(19) United States
(12) Patent Application Publication
(10) Pub. No.: US 2023/0182278 A1
(43) Pub. Date: Jun. 15, 2023

(54) A TOOL FOR DRIVING A STAKE INTO THE GROUND

(71) Applicant: COPPERVILLE PTY LTD, Kadina (AU)

(72) Inventor: David Owen Prior, Kadina (AU)

(73) Assignee: COPPERVILLE PTY LTD, Kadina (AU)

(21) Appl. No.: 17/921,743

(22) PCT Filed: May 4, 2021
(86) PCT No.: PCT/AU2021/050412

§ 371 Date: Oct. 27, 2022

(30) Foreign Application Priority Data
May 5, 2020 (AU) 2020901431

(51) Int. Cl. B25D 1/16; E04H 15/62

(52) U.S. Cl. CPC B25D 1/16; E04H 15/62

(57) ABSTRACT

A tool 10 for driving a stake 14 into the ground, the tool 10 comprising a sleeve 12 for receiving therein the stake 14 and defining a first aperture 30 at an end into which the stake 14 can be inserted, and a plunger 34 slidingly receivable within the sleeve 12 and extendable through a second aperture 51 of the sleeve 12, the plunger 34 comprising a first end 38 for receiving a strike force and a second end 36 for contacting the stake 14, wherein the plunger 34 is arranged to transfer the strike force received at the first end 38 to the stake 14 via the second end 36.

### TECHNICAL FIELD

The disclosure herein generally relates to a tool for driving a stake into the ground, and particularly but not exclusively to a tool for driving a tent peg into the ground.

### BACKGROUND

An example of a stake is a tent peg, which can be used to secure a structure, the structure usually being in the form of a tent to the ground. Stakes in the form of tent pegs or having another form may also be used to secure generally any suitable structure to the ground, other examples of which include, but are not limited to, gazebos and fly sheets.

FIG. 1 shows an example of a stake in the form of a tent peg, the stake being generally indicated by the numeral 1. The stake 1 comprises a round steel rod 18 bent adjacent one end thereof 20 to form a hook 22 at the head 5 of the stake 1. Also formed is a shank 24 and a bend 26 in the form of an elbow intermediate the end 20 and the shank 24.

The distal end 2 of shank 24 terminates with a ground piercing point 3, in this embodiment formed by an oblique cut of the shank 24. A loop of a ribbon or a guy rope, for example, may be received within elbow 26 when the distal end of the shank 24 is disposed of in the ground. Alternatively, the shank 24 can also be inserted through an eyelet. The angle subtended by the ends 2 and 20 at the elbow 26 is generally around 75 degrees, however this angle may be in the range of, for example, 60 degrees to 85 degrees, or the angle may be above or below this range.

FIG. 2 shows another example of a stake 2, where parts similar in form and/or function to those in FIG. 1 are similarly numbered. The stake 2 comprises a crook 4. An axis of the shank 24 and an axis of the end 20 intersect at an angle of generally around 75 degrees, however this angle may vary.

Stakes can be urged into soft ground by hand, and urged into harder ground by striking the stake with a striking tool in the form of a hammer (e.g. carpenter’s hammer, sledge hammer), a mallet, or generally any suitable form of striking tool.

The stake can be inadvertently bent or otherwise deformed when urged into the ground, especially when urged into hard ground, or if a tree root or rock is contacted. It can be difficult to strike a stake effectively, which may have a small head for striking, or may have a curved end which is poorly suited for being struck with a striking tool, resulting in a poor transfer of striking force.

The striking tool may be easily deflected by an inaccurate blow, which can be dangerous and/or impede rapid urging of the stake into the ground.

### SUMMARY OF INVENTION

According to a first aspect of the present invention, there is provided a tool for driving a stake into the ground, the tool comprising: a sleeve for receiving therein the stake and defining a first aperture at an end into which the stake can be inserted, the sleeve comprising at least two elongated surfaces which receive and guide a shank of the stake; and a plunger slidingly receivable within the sleeve and extendable through a second aperture of the sleeve, the plunger comprising a first end for receiving a strike force and a second end comprising a stake head contacting surface that is oblique to an axis of the plunger, wherein the plunger is arranged to transfer the strike force received at the first end to the stake coaxially to the shank of the stake via the second end, and wherein the stake head contacting surface is arranged to urge the shank of the stake to maintain contact with the at least two elongated surfaces.

In an embodiment, the second end of the plunger comprises a surface which contours to the shape of head of the stake.

In an embodiment, the second end of the plunger comprises a stake head contacting surface that is oblique to a longitudinal axis of the plunger.

In an embodiment, the surface is inclined at an angle of between 5 and 40 degrees with respect to a plane normal to the axis of the plunger.

In an embodiment, the surface is inclined at an angle of between 10 and 20 degrees with respect to a plane normal to the axis of the plunger.

In an embodiment, the stake head contacting surface is inclined at an angle of about 15 degrees with respect to a plane normal to a longitudinal axis of the plunger. In an embodiment, the surface is inclined at an angle of about 35 degrees with respect to a plane normal to an axis of the plunger.

In an embodiment, the stake head contacting surface is within a groove for receiving and positioning the head of the stake.

In an embodiment, the groove is rounded in cross-section.

In an embodiment, the sleeve comprises an elongated stake-shank receiving concave portion for receiving a shank of the stake.

In an embodiment, the elongated stake-shank receiving concave portion comprises an internal corner of the sleeve.

In an embodiment, the elongated stake-shank receiving corner provides support from one or more internal surfaces of the sleeve.

In an embodiment, the elongated stake-shank receiving corner contours to the shape of the shank of the stake.

In an embodiment, the stake-shank receiving corner is a rounded groove. In an embodiment, the stake-shank receiving corner is a ‘V’ shaped groove. In an embodiment, the groove may comprise retaining means to retain a contacted stake.

In an embodiment, the second end of the plunger comprises a surface configured to contact the stake and urge the shank of the stake into the elongated stake-shank receiving corner.

In an embodiment, the surface is oblique to an axis of the plunger. In an embodiment, the surface slants at an angle from a longitudinal axis of the plunger.

In an embodiment, the sleeve defines a passageway having a substantially quadrilateral transverse section. In an embodiment, the plunger is formed having a substantially quadrilateral transverse cross section.

In an embodiment, the sleeve defines a passageway having a substantially circular cross section. In an embodiment, the cross section of the sleeve is eccentric. In an embodiment, the sleeve cross section is an irregular shape. In an embodiment, the cross section of the sleeve is substantially a teardrop shape.

In an embodiment, the stake contacting end of the plunger is replaceable with one of a plurality of stake contacting ends. Each stake contacting end comprises a unique surface. Each surface comprises a shape and slant angle contoured to receive a specific stake head. In an embodiment, the contour of each surface may be angled relative to a horizontal cross section of the sleeve. The angle may be such that when the stake head is inserted in the sleeve and received by the respective surface, the shank of the stake is urged to the elongated stake-shank receiving corner.

In an embodiment, the second end of the plunger is replaceable.

In an embodiment, the surface is within a groove defined by the stake contacting end. The groove defined by the stake contacting end may be rounded.

In an embodiment, the groove may extend diagonally along the stake head contacting surface.

In an embodiment, the sleeve defines a channel configured for sliding a protrusion of the stake head.

In an embodiment, the slot, a centreline of the groove defined by the stake contacting end and the stake shank receiving corner may be coplanar.

In an embodiment, the plunger is slidingly received within the sleeve.

In an embodiment, the plunger is inseparable from the sleeve.

In an embodiment, the actuation end of the plunger is replaceable.

In an embodiment, the actuation end of the plunger comprises a plunger head and the sleeve comprises a plunger head seat adjacent to the second aperture of the sleeve.

In an embodiment, the plunger head comprises a material suitable for being repeatedly struck with a hammer. The plunger head comprises steel.

In an embodiment, the stake is a tent peg.

According to a second aspect of the invention, there is provided a tool for driving a stake into the ground, the tool comprising:
a sleeve for receiving therein the stake and defining a first aperture at an end into which the stake can be inserted, the sleeve comprising at least two elongated internal surfaces which receive and guide a shank of the stake; and
a plunger slidingly receivable within the sleeve, the plunger comprising an end for contacting the stake, wherein the end of the plunger comprises a surface that is oblique to an axis of the plunger and shaped to distribute force over an upper face of head of the stake, wherein the plunger is arranged to transfer a force received to the stake via the shaped surface and wherein the upper face of head of the stake is arranged to urge the shank of the stake to maintain contact with the at least two elongated surfaces.

In an embodiment, the end of the plunger comprises a surface which contours to the shape of head of the stake.

In an embodiment, the end of the plunger comprises a stake head contacting surface that is oblique to a longitudinal axis of the plunger.

In an embodiment, the surface is inclined at an angle of between 5 and 40 degrees with respect to a plane normal to the axis of the plunger.

In an embodiment, the surface is inclined at an angle of between 10 and 20 degrees with respect to a plane normal to the axis of the plunger.

In an embodiment, the stake head contacting surface is inclined at an angle of about 15 degrees with respect to a plane normal to a longitudinal axis of the plunger. In an embodiment, the surface is inclined at an angle of about 35 degrees with respect to a plane normal to an axis of the plunger.

In an embodiment, the stake head contacting surface is within a groove for receiving and positioning the head of the stake.

In an embodiment, the groove is rounded in cross-section.

According to a third aspect of the invention, there is provided a tool for driving a stake into the ground, the tool comprising:
a sleeve for receiving therein the stake and defining a first aperture at an end into which the stake can be inserted, and
a plunger slidingly receivable within the sleeve, the plunger comprising a concave portion for receiving a shank of the stake, wherein the plunger is arranged to transfer a force received to the stake and the concave portion guides the shank.

According to a fourth aspect of the present invention, there is provided a tool for driving a stake into the ground, the tool comprising:
a sleeve for receiving therein the stake and defining a first aperture at an end into which the stake can be inserted, the sleeve comprising at least two elongated surfaces for receiving a shank of the stake; and
plunger slidingly receivable within the sleeve, wherein the plunger comprises a surface that is oblique to an axis of the plunger and is arranged to a transfer a force received to the stake and the at least two elongated surfaces guides the shank, and surface of the plunger is arranged to urge the shank of the stake to maintain contact with the at least two elongated surfaces.

According to a fifth aspect of the present invention, there is provided a method for driving a stake into the ground comprising:
providing a tool comprising a sleeve having a first end and a second end, and a plunger slidably received within the sleeve such that a portion of the plunger and a first end of the plunger extend past the first end of the sleeve;
inserting the stake through the second end of the sleeve to abut a second end of the plunger that is oblique to the axis of the plunger such that a ground piercing end of the stake is directed outward of the second end of the sleeve wherein a shank of the stake is received in and guided by at least two elongated surfaces of the sleeve;
placing the second end adjacent to the ground where the stake is to be driven;
applying an impact force to the first end of the plunger; and
transferring the force to the stake via the second end of the plunger thereby urging the shank of the stake to maintain contact with the at least two elongated surfaces and driving the stake into the ground.

In an embodiment, the method further comprises a head of the stake is received by a contoured surface of the second end of the plunger so as to transfer the force to an upper surface of the head of the stake.

According to a sixth aspect of the present invention, there is provided a tool for driving a stake into the ground, the tool comprising a sleeve for receiving therein the stake and defining a first aperture at an end into which the stake can be inserted, and a plunger slidingly receivable within the sleeve and extendable through a second aperture of the sleeve, the plunger comprising a first end for receiving a strike force and a second end for contacting the stake; wherein the plunger is arranged to transfer the strike force received at the first end to the stake via the second end.

Any of the various features of each of the above disclosures, and of the various features of the embodiments described below, can be combined as suitable and desired.

### BRIEF DESCRIPTION OF DRAWINGS

Embodiments will now be described by way of example only with reference to the accompanying figures in which:

FIGS. 1 and 2 each show an example of a stake;

FIG. 3 shows a front elevational view of an embodiment of a tool for driving a stake into the ground, the tool being shown in a disassembled state according to the present invention;

FIG. 4 shows a top-front isometric view of the tool of FIG. 3;

FIG. 5 shows a bottom-rear isometric view of the tool of FIG. 3;

FIG. 6 shows a bottom-side isometric view of the tool of FIG. 3 and an example of a stake that the tool of FIG. 3 can be disposed of, in the ground;

FIG. 7 shows an isometric view of the tool having the plunger head positioned on the plunger head seat, according to an embodiment of the present invention; and

FIG. 8 shows a bottom view of the tool, according to an embodiment of the present invention.

### DESCRIPTION OF THE EMBODIMENT

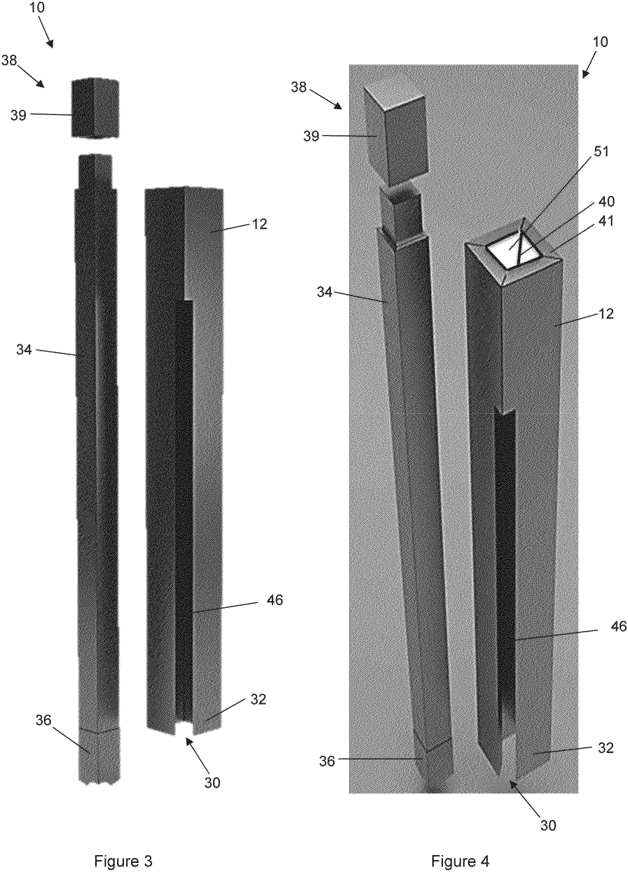

FIGS. 3-6 show various views of embodiments of a tool 10 for driving a stake 14 into the ground, the tool 10 being shown in a disassembled state. The tool 10 comprises a sleeve 12 for receiving therein a stake 14, for example in the form of a tent peg, which is shown in FIG. 6. The sleeve 12 defines a first aperture 30 at an end 32 thereof. A head of the stake 14 can be inserted into the aperture 30 at the end 32 such that the ground piercing end 3 of the stake 14 is directed outwardly with respect to the aperture 30. The tool 10 comprises a plunger 34 that is, in this embodiment, telescopically slidingly receivable within the sleeve 12. In one embodiment, the plunger 34 is inseparable from the sleeve 12, but is shown separated for illustrative purposes. In an alternative embodiment, however, the plunger 34 may be separable from the sleeve 12.

The plunger 34 comprises a first end for actuation, hereinafter referred to as an actuation end 38, and in this embodiment is configured to be struck with a striking tool, such as a hammer or mallet. The person skilled in the art would understand that the term ‘striking tool’ is to be interpreted broadly and may include an object which is capable of imparting a striking force upon the actuation end 38. The plunger 34 may also be formed so as to define a hand grip such that a user may use their own strength to drive the stake into the ground. The hand grip used for imparting a driving force may be formed integrally with the plunger head 39.

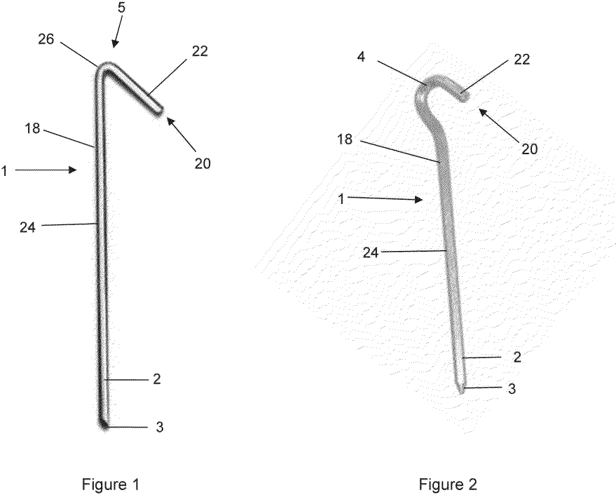

The plunger 34 further comprises a second end, hereinafter referred to as a stake contacting end 36, for receiving and contacting at least a portion of the stake 14. In one embodiment, the stake contacting end 36 receives and contacts the head of the stake 14 when the head of the stake 14 is inserted into the end 32 through the first aperture 30 such that the ground piercing end 3 (as seen in FIGS. 1 and 2) of the stake 14 is directed outwardly with respect to the first aperture 30. In some embodiments, when contacted the ground piercing end 3 of the stake 14 protrudes from the first aperture 30. In some embodiments, the stake 14 is received by the stake contacting end 36 such that the head of the stake 14 contacts the stake contacting end 36. The stake 14 is held in place between the plunger 34 and the ground piercing end 3 when in contact with the ground.

The actuation end 38 may comprise a plunger head 39 having a substantially flat distal surface for being struck by the striking tool. The plunger head 39 may be curved to a small degree to allow inaccurate striking angles, and/or textured to inhibit slippage. Preferably, the plunger head 39 comprises a material, such as a steel, which is suitable for being repeatedly struck with a hammer. Alternatively, the plunger head 39 material may comprise titanium, an alloy, another metal, rubber or a polymer which may provide cushioning, a combination of the aforementioned materials or generally any other suitable material.

The sleeve 12 comprises a plunger head seat 41 in the form of a rim at a second aperture 51 of the sleeve 12. The plunger head 39 can be seated on the plunger head seat 41. Travel of the plunger 34 is stopped when the plunger head 39 is seated on the plunger head seat 41. Plunger head 39 comprises a socket that receives a section of the shaft of the plunger 34. Preferably, the socket is square in cross-section. The plunger head 39 may be attached to the plunger 34 by a mechanical fastener, such as a pin or screw. Alternatively, adhesives or other suitable known fastening means may be used to attach the plunger head 39 to the plunger 34.

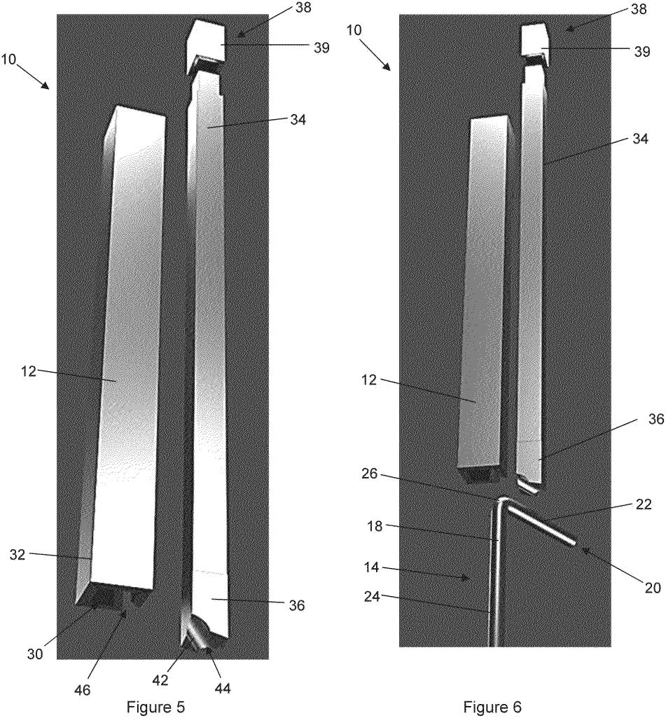

The sleeve 12 is substantially a hollow section defining an elongated cavity or substantially straight passageway having a polygonal transverse cross-section. Preferably extending between the apertures 30 and 51. The polygon is in this embodiment a quadrilateral, specifically diamond shaped, however it may be square, rectangular, pentagonal, substantially circular or have generally any other suitable shape. The sleeve 12 has an exterior quadrilateral shape that is congruent with the interior, however it may have a round exterior shape or generally any other suitable shape. Preferably, the sleeve 12 comprises an internal elongated stake-shank receiving concave portion, such as an internal corner 40, for receiving the shank 24 of the stake 14. As seen in FIG. 5, the stake contacting end 36 of the plunger 34 may be configured with a surface 42 which contacts the head of stake 14 and urges the shank 24 of the stake 14 into the elongated stake-shank receiving corner 40. The elongated stake-shank receiving corner 40 can provide support to the shank 24 when the stake 14 is being driven into the ground. Support of the shank 24 of the stake by one or more internal surfaces of the sleeve 12 may reduce the likelihood of the stake being bent and/or deformed.

The surface 42 is preferably oblique to an axis of the shank 24. When stake 14 interfaces with the surface 42, the shank 24 of the stake 14 is directed into the elongated stake-shank receiving corner 40. As seen in FIG. 6, the surface 42 may have a groove 44 which receives the head of stake 14 which may further improve the radial orientation, relative to the longitudinal axis, of the stake 14 and improve the direction of the stake 14 into the corner 40. The groove 44 is preferably a rounded groove 44 defined within the stake contacting end 36. The surface 42 of the stake contacting end 36 may be inclined at an angle of between 5 and 40 degrees with respect to a plane normal to a longitudinal axis of the plunger 34, for example between 10 and 20 degrees, and specifically for this but not all embodiments at about 15 degrees. Preferably, the stake head contacting surface 42 is preferably angled such that when the head of the stake 14 is received in groove 44, the shank 24 of the stake 14 is urged to be supported by the elongated stake-shank receiving corner 40. The surface 42 and/or the groove 44 may be curved such that it or they contour to the shape of the head of the respective stake 14. Accordingly, the shape and path of the preferable groove 44 is determined by the orientation of the head of the respective stake 14 when the shank of the respective stake 14 is being supported by the elongated stake-shank receiving corner 40.

The sleeve 12 may comprise a slot 46 configured to accommodate a protrusion 20 of the head of the stake 14. The protrusion 20 of the head of the stake 14 translates along an axis parallel to the plunger 34. The slot 46 may further assist in the axial orientation of the stake 14 within the sleeve 12. The slot 46, a centreline of the groove 44 and the stake shank receiving corner are preferably coplanar. The slot 46 being configured to receive the protrusion 20 of the head of the stake 14 during operation may enable a reduction of the overall transverse dimensions of the sleeve 12.

In an embodiment, the stake contacting end 36 is removable from the plunger 34. As different stake types can have different shaped heads, the surface 42 of the stake contacting end 36 of a matching type of stake contacting end 36 can be profiled to mate with and/or confirm with each of a selection of the different shaped heads. Accordingly, the appropriate type of stake contacting end 36 can be selected and attached to the plunger 34.

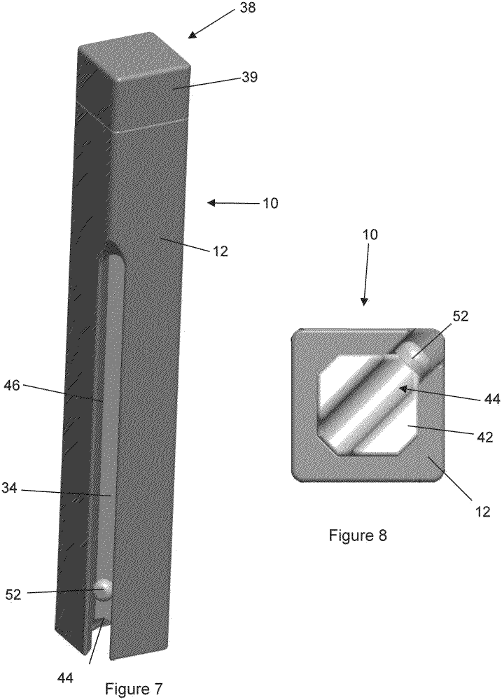

Referring to FIGS. 7 and 8, the plunger 34 further comprises a protrusion, such as a pin 52. The pin 52 is arranged to slide within slot 46. When assembled, the pin 52 reaches the end of the slot 46 in one direction and plunger head 39 in the other direction prevents separation of the plunger 34 from the sleeve 12. The pin 52 may be formed integrally with the plunger 34. The pin 52 may be connected to the plunger 34 by alternative fastening means, such as a complementary screw and threaded connection. Further the pin 52 may be able to retreat into the plunger 34, preferably be overcoming a spring urging the pin 52 outward, so that when the pin 34 is pushed into the plunger 34 the plunger 34 may be removed from the sleeve 12.

The sleeve 12 preferably comprises a resilient material, such as steel. The sleeve 12 material should be suitable to receive repetitive high impacts at the seat 41 from the plunger head 39. Alternative embodiments may comprise a polypropylene produced by propane dehydrogenation (PDH) or a polymer to decrease mass, for example, which may be more attractive to walkers carrying tents and tent pegs, for example.

Referring to the figures the method of use and operation of the present invention will now be described.

A user will take a stake 14 and in one embodiment check that the stake contacting end 36 is the corresponding type to the stake 14. If it is not, then the current stake contacting end 36 is removed and changed for the corresponding type.

The stake 14 is then inserted into the aperture 30 and abutted with the surface 42 and preferably the groove 42 so as to guide the shake of the stake into the stake-shank receiving corner 40.

The ground penetrating end of the stake 14 projecting from the aperture is positioned as desired on the ground where it is to be driven in. The stake contacting end 36 is in contact with the head of the stake 14. The actuation end 38 of the plunger 34 is then actuated, preferably by being struck by a striking tool, such as a hammer.

The impact of the striking tool will be received by the actuation end 38, transferred through the plunger 34 and then transferred from the stake contacting end 36 to the stake 14, due to the stake contacting end 36 being in contact with the head of the stake 14, without there being a gap between the stake contacting end 36 and the head of the stake 14 that needs to be closed. In particular, the surface 42, and preferably the groove 44, ensure that the force is transferred substantially to the shank of the stake 14 in a manner that is co-axial with the shank. Thus, in this embodiment, there is no striking of the head of the stake 14 by the plunger 34 because the plunger 34 is already in contact with the head of the stake 14.

In an alternative form, the stake contacting end 36 of the plunger 34 may act as a hammer striking the head of the stake 14, but in that case the surface 42, and preferably the groove 44 ensure that the impact force is evenly received by the head of the stake 14.

Further, in both alternatives, the stake-shank receiving corner 40 ensures the stake 14 is steady and directed in the desired direction when it receives the force driving it into the ground.

Thus, the stake 14 may be driven into the ground by receiving one or more occurrences of the force driving it into the ground.

Now that embodiments have been described, it will be appreciated that some embodiments may have at least some of the following advantages:
The strike force may be distributed more evenly over the head of the stake.
The strike force may be delivered more efficiently and effectively to a stake.
The strike force may be directed co-axially with the shank.
The stake may be installed with minimal disruption to an area of surrounding earth. With minimal disruption to the surrounding earth, each stake is able to more effectively restrain a load.
The stake may be held in the supporting corner, reducing bending or twisting of the stake.

Variations and/or modifications may be made to the embodiments described without departing from the spirit or ambit of the invention. For example:
The stake 14 may take any suitable form, and embodiments of the tool 10 may be adapted as required for the stake 14, examples of which include but are not limited to:
   A galvanised or a non-galvanised steel tent peg.
   ◯A polycarbonate tent peg.
   An aluminium alloy tent peg.
   A snow stake.
   A sand stake.
   A tarp stake.
   A pressed metal stake.
   A peg comprising an angle shank.
   A key-headed peg.
   A hook-headed peg.
   A heavy duty peg.
   A light duty peg.
   A rock stake.
   A stake comprising a ribbed shank.
   A stake having a guy rope hook.
   A stake without a guy rope hook.
   A stake with a crinkle-cut shank.
   A stake for a gazebo or a fly.
The groove 44 may be in the form of a rabbet or rebate cut with a dado set or formed during a casting process, for example.
The tool 10 may comprise aluminium alloy, composite, a polymer, or generally any suitable material as suitable and desired.
The plunger 34 may have round transverse sections or transverse sections of other shapes.
The slot 46 may extend to the plunger head seat 41 and may cut through it.
The plunger 34 may not have a plunger head 39 configured to be stopped by the plunger head seat 41.
The plunger head 39 may be separable or integral to the plunger 34.
The groove 44 may not be present.
The groove may be replaced with guiding pegs or other form of orientation guide.
A low friction material may be disposed between the sleeve 12 and the plunger 34, for example a polytetrafluoroethylene (such as “TEFLON” ™) (or other polymer) bushing or a plurality of skids.

The plunger 34 may comprise a handle for hand actuation, or otherwise a hammer or mallet may be used to deploy the stake 14 into the ground.

The present embodiments are, therefore, to be considered in all respects as illustrative and not restrictive. Reference to a feature disclosed herein does not mean that all embodiments must include the feature.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1. A tool for driving a stake into the ground, the tool comprising:
a sleeve for receiving therein the stake and defining a first aperture at an end into which the stake can be inserted, the sleeve comprising at least two elongated surfaces which receive and guide a shank of the stake; and
a plunger slidingly receivable within the sleeve and extendable through a second aperture of the sleeve, the plunger comprising a first end for receiving a strike force and a second end comprising a stake head contacting surface that is oblique to an axis of the plunger, wherein the plunger is arranged to transfer the strike force received at the first end to the stake coaxially to the shank of the stake via the second end, and wherein the stake head contacting surface is arranged to urge the shank of the stake to maintain contact with the at least two elongated surfaces.

2. A tool according to claim 1, wherein the second end of the plunger comprises a surface which contours to the shape of head of the stake.

3. A tool according to claim 1, wherein the at least two elongated surfaces are at, or each comprise a tangent at, a right or an obtuse angle to each other.

4. A tool according to claims 1, wherein the stake head contacting surface is inclined at an angle of about 15 degrees with respect to a plane normal to a longitudinal axis of the plunger.

5. A tool according to claim 1, wherein the stake head contacting surface is within a groove for receiving and positioning the head of the stake.

6. A tool according to claim 5, wherein the groove defined by the second end is rounded.

7. A tool according to claim 1, wherein the at least two elongated surfaces extend substantially the length of the sleeve.

8. A tool according to claims 6, wherein the at least two surfaces form an elongated stake-shank receiving concave portion.

9. A tool according to claim 1, wherein the elongated stake-shank receiving concave portion comprises an internal corner of the sleeve.

10. A tool according to claim 1, wherein the sleeve defines a passageway having a substantially quadrilateral transverse section.

11. A tool according to claim 1, wherein the second end of the plunger is replaceable.

12. A tool according to claim 9, wherein the sleeve defines a slot configured for sliding protrusion of the stake head.

13. A tool according to claim 12, wherein the slot, a centreline of the groove and the elongated stake shank receiving concave portion are coplanar.

14. A tool according to claim 1, wherein the first end of the plunger comprises a plunger head and the sleeve comprises a plunger head seat at the first aperture of the sleeve.

15. A tool according to claim 1, wherein the stake contacting surface terminates substantially the same as where the stake head terminates.

16. A tool according to claim 1, wherein the stake comprises a tent peg.

17. A tool for driving a stake into the ground, the tool comprising:
a sleeve for receiving therein the stake and defining a first aperture at an end into which the stake can be inserted, the sleeve comprising at least two elongated internal surfaces which receive and guide a shank of the stake; and
a plunger slidingly receivable within the sleeve, the plunger comprising an end for contacting the stake, wherein the end of the plunger comprises a surface that is oblique to an axis of the plunger and shaped to distribute force over an upper face of head of the stake, wherein the plunger is arranged to transfer a force received to the stake via the shaped surface and wherein the upper face of head of the stake is arranged to urge the shank of the stake to maintain contact with the at least two elongated surfaces.

18.A tool for driving a stake into the ground, the tool comprising:
a sleeve for receiving therein the stake and defining a first aperture at an end into which the stake can be inserted, the sleeve comprising at least two elongated surfaces for receiving a shank of the stake, and
a plunger slidingly receivable within the sleeve, wherein the plunger comprises a surface that is oblique to an axis of the plunger and is arranged to transfer a force received to the stake and the at least two elongated surfaces guides the shank, and surface of the plunger is arranged to urge the shank of the stake to maintain contact with the at least two elongated surfaces.

19. A method for driving a stake into the ground comprising:
providing a tool comprising a sleeve having a first end and a second end, and a plunger slidably received within the sleeve such that a portion of the plunger and a first end of the plunger extend past the first end of the sleeve;
inserting the stake through the second end of the sleeve to abut a second end of the plunger that is oblique to the axis of the plunger such that a ground piercing end of the stake is directed outward of the second end of the sleeve wherein a shank of the stake is received in and guided by at least two elongated surfaces of the sleeve;
placing the second end adjacent to the ground where the stake is to be driven;
applying an impact force to the first end of the plunger; and
transferring the force to the stake via the second end of the plunger thereby urging the shank of the stake to maintain contact with the at least two elongated surfaces and driving the stake into the ground.

20. The method according to claim 19, wherein a head of the stake is received by a contoured surface of the second end of the plunger so as to transfer the force to an upper surface of the head of the stake.
